(19) United States
(12) Patent Application Publication
(10) Pub. No.: US 2011/0097485 A1
(43) Pub. Date: Apr. 28, 2011

(54) SMART SHINGLES

(76) Inventors: Winston Breeden, Chagrin Falls, OH (US); Darren Kenneth Smith, Westlake, OH (US); Thaddeus T. Brej, Rocky River, OH (US)

(21) Appl. No.: 12/909,973

(22) Filed: Oct. 22, 2010

Related U.S. Application Data
(60) Provisional application No. 61/253,906, filed on Oct. 22, 2009.

(51) Int. Cl. B05C 17/03; B05C 1/12; B05C 1/08

(52) U.S. Cl. 427/186; 401/197; 118/206

(57) ABSTRACT

A system and associated method applies a fluid to a surface. In particular, the system applies a roof surface covering to an existing roof location of a building. The system includes a pump for providing a pressurized source of fluid, a fluid conduit for extending from the pump to the roof location and delivering the fluid to the roof location, and an applicator device for applying the delivered fluid to the roof location to provide a portion of the applied roof surface. The system also includes a granule supply device for proving loose granules, a granule conduit for extending from the granule supply device to the roof location and delivering the loose granules to the roof location, and a dispenser for dispensing the loose granules onto the applied fluid on the roof location to provide another portion of the applied roof surface. The pump may be a peristaltic pump and the fluid does not directly engaging any surface of the pump. The applicator device may include a roller. Portions of the applicator device permit release of the roller without engagement of the roller by the user.

### CROSS REFERENCE TO RELATED APPLICATIONS

The present application claims benefit of U.S. Provisional Patent Application Ser. No. 61/253,906, filed Oct. 22, 2009, which is incorporated herein by reference.

### BACKGROUND OF THE INVENTION

1. Field of the Invention

The present invention relates to roofing systems on buildings and specifically relates to a roofing system for a building that has an existing roof location.

2. Discussion of Prior Art

It is known to provide a roof covering for buildings, such house dwellings, to have applied shingles. The shingles are typically arranged in an overlapping row configuration. Unfortunately, a numerous plurality of shingles is typically utilized for each individual roof. Also, the individual shingles are individually applied. Each shingle is typically applied with a fastener, such as a nail or staple, which penetrates through the shingle and to an underlying structure (e.g. a wooden support layer).

The construction of a typical shingle may include fibrous material such as fiber glass, a petroleum based material such as asphalt, and is top-coated with aggregate mineral granules. Over time, shingles may deteriorate due to weather conditions and/or other adverse conditions such as impacting items (e.g., hail). Also, a shingle based roof may develop leaks due to shingle deterioration or other factors.

It is possible to recover an existing shingle roof with another layer of shingles. Very commonly, old shingles are removed (e.g. torn off) prior to application of a new shingling. Both approaches are labor and cost intensive.

There is a need for improved roofing systems and methodologies to provide improved performance and less cost/labor effectiveness.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides a system for applying a roof surface covering to an existing roof location of a building. The system includes a pump for providing a pressurized source of fluid, a fluid conduit for extending from the pump to the roof location and delivering the fluid to the roof location, and an applicator device for applying the delivered fluid to the roof location to provide a portion of the applied roof surface. The system also includes a granule supply device for proving loose granules, a granule conduit for extending from the granule supply device to the roof location and delivering the loose granules to the roof location, and a dispenser for dispensing the loose granules onto the applied fluid on the roof location to provide another portion of the applied roof surface.

In accordance with another aspect, the present invention provides a system for applying a fluid to a surface. The system includes a peristaltic pump for providing a pressurized source of fluid and a fluid conduit through and from the pump to surface location and for delivering the fluid to the surface location. The fluid conduit contains the fluid and the fluid not directly engaging any surface of the pump. The system also includes an applicator device for applying the delivered fluid to the surface. The applicator device includes a handle for manual grasping by a user, a head for receiving the fluid from the source, and a roller located at the head for transferring the fluid from the head to the surface during a rolling motion of the roller relative to the head.

In accordance with another aspect, the present invention provides a method for applying a roof surface covering to an existing roof location of a building. The system includes operating a pump to provide a pressurized source of fluid, moving the fluid within a fluid conduit extending from the pump to the roof location and delivering the fluid to an applicator device, and operating the applicator device to apply the fluid to the roof surface. The method also includes operating a granule supply device to provide loose granules, conveying the loose granules along a granule conduit from the granule supply device to the roof location, and dispensing the loose granules onto the applied fluid on the roof surface via a dispenser connected with the granule conduit.

In accordance with another aspect, the present invention provides a method for repairing an existing roof location by applying a new roof surface covering. The method includes applying a fluid while in a liquid state directly to an existing roof location which will subsequently dry or cure to become a non-liquid that remains adhered to the existing roof location, and applying a granules onto the fluid while the liquid is in the liquid state such that some portion of the granules remain exposed while still being adhered to the fluid after it subsequently dries or cures to a non-liquid state.

In accordance with another aspect, the present invention provides a roller applicator device for applying a fluid to a location. The device includes a handle portion for manual grasping by a user, a connection portion for connection to a pressurized source of the fluid, a distribution head for receiving the fluid from the source via the connection portion, and a roller located at the distribution head for transferring the fluid from the distribution head to the location during a rolling motion of the roller relative to the location. The roller includes at least one member rotationally supporting the roller relative to the distribution head. The distribution head includes at least one engagement portion for engaging the at least one member. The device also includes at least one retainer for retaining the at least one member and the roller relative to the head during the rolling motion of the roller. The at least one member, the at least one engagement portion and the at least one retainer are constructed and configured to permit release of the roller from the head without engagement of the roller by the user.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic illustration of a first portion of a system for applying a roof surface covering to an existing roof location of a building;

FIG. 2 is a schematized perspective illustration of an example pump which may be used within the portion of the system shown in FIG. 1;

FIG. 3 is a partially torn away view of a liquid conduit section and a valve which may be utilized within the portion of the system showed within FIG. 1;

FIG. 4 is a schematic illustration of an operator using an example roller device of the portion of the system shown in FIG. 1 and upon the existing roof location;

FIG. 5 is a plan view of the example roller device of the portion of the system shown in FIG. 1;

FIG. 6 is an enlarged, partially sectioned view of an example distribution head portion of the roller device shown in FIG. 5;

FIG. 7 is a schematized view of an end portion of the roller device of FIG. 5;

FIG. 8 is an enlarged view of an end of an example nap roller for location within the of the roller device of FIG. 5;

FIG. 9 is an enlarged, partial view of the end portion shown in FIG. 7 and shows the example roller of FIG. 8 mounted within the roller device;

FIG. 10 is a prospective, exploded view of portions of the head of the roller device of FIG. 5 and in the same orientation as shown within FIG. 6;

FIG. 11 is a schematic illustration of a second portion of the system for applying the roof surface covering to the existing roof location on the building:

FIG. 12 is a schematic illustration of an operator operating an example granular dispenser of the portion of the system shown within FIG. 11;

FIG. 13 is an example of a mix eductor which can be utilized within the portion of the system shown within FIG. 11;

FIG. 14 is an illustration of a conduit guard that may be optionally used within the system shown in FIGS. 1 and 11; and

FIG. 15 is an illustration of a roof stand that may be optionally used within the system shown in FIGS. 1 and 11.

### DETAILED DESCRIPTION OF THE INVENTION

Illustrative embodiments that incorporate one or more aspects of the invention are described and illustrated in the drawings. These illustrated examples are not intended to be overall limitations on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

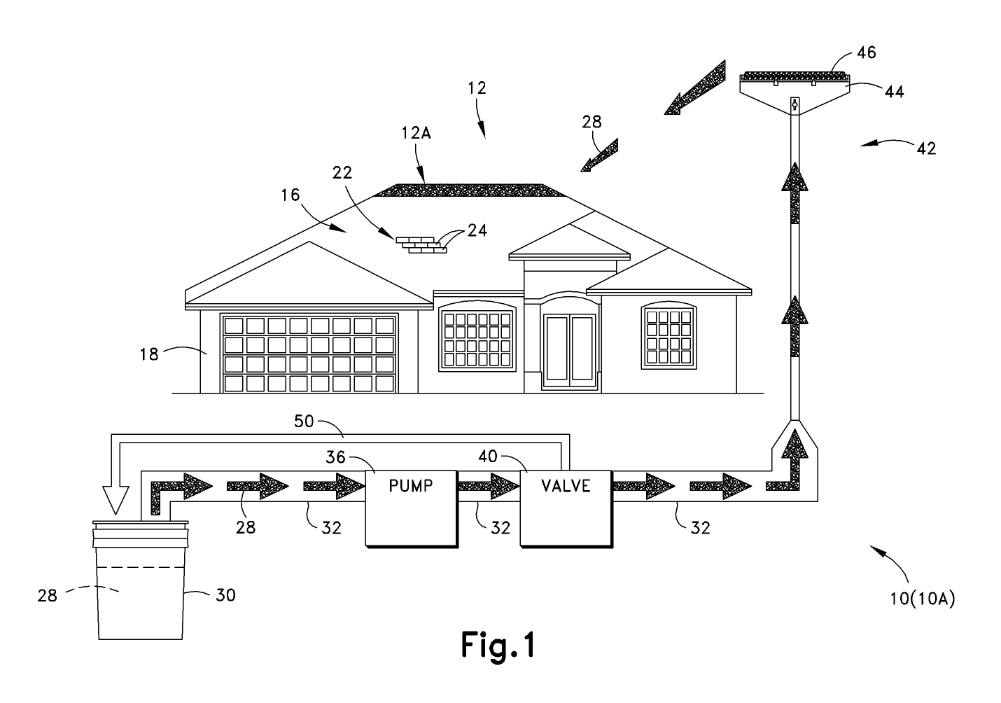

An example of a portion 10A of a system 10 for applying a roof surface covering 12 to an existing roof location 16 of a structure 18 (e.g., a building) is schematically illustrated in FIG. 1. Also shown within FIG. 1 is an example of the structure 18 (e.g., the building, herein the structure is simply referred to as the building) that has the existing roof location 16. The type of building 18 shown within FIG. 1 is merely an example. The shown example building 18 is a residential dwelling. It is to be appreciated that the type of building 18 may be varied.

Within one example, the roof location 16 has an existing roof system 22 constructed of applied shingles 24 (only partially shown to avoid drawing clutter). The shingles 24 may be the commonly known asphalt-based, fiberglass-based or the like. The shingles 24 may or may not include fibrous material such as fiberglass. The individual shingles 24 are applied to the building 18 via fasteners (e.g. nails and/or staples) to an underlying structure (e.g. wood, such as plywood, nailed onto rafters of the building). The existing shingles 24 may be a commonly known “three-tab shingle” which has three panel sections separated by two slice-removed segments to provide a pattern appearance. Alternatively, the shingles may have any other configurations or aesthetic appearance. For example, the shingles may be another shingle type commonly referred as to “dimensional” or “architectural” shingles and which have a combination of slices for panel separation, raised panels, or the like. In general, the existing roof system 22 has a texture (not smooth because the existence of sliced removed portions, raised panels, or the like). Such texturing is often for aesthetic appearances.

Also, it is to be appreciated that the existing shingles 24 may have included granule material adhered to an uppermost/exposed portion. The granule material may help protect other portions (e.g., under layers) from the elements and/or provide for aesthetic aspects, such as surface texturing and/or coloration.

Still further, it should be appreciated that the roof location 16 of the example building 18 is shown to have pitched or sloped portions, such as gable portions, hip portions and can possibly include other types of roof configurations. In general, it should be appreciated that the specifics of the building 18 and the roof location 16 may not be specific limitations upon the present invention.

The existing roof system 22 may be aged and/or degraded, so the condition of the existing roof system may be varied greatly. In general, the existing roof system 22 may have one or more problems. For example, the existing roof system 22 may leak. The existing roof system 22 may have one or more missing shingles or partially missing shingles. Still further, one or more of the shingles 24 within the existing roof system 22 may be damaged or otherwise degraded. Examples of such damage include impact damage by articles such as hail, tree branches, or the like. Degradation may include lifted or curled shingles, cracking and/or edge peeling of the individual shingles 24. Dependent upon the current state of the existing roof system 22, the granule material may be present or partially/completely missing.

Turning to the portion 10A of the example system 10 shown within FIG. 1, it should be appreciated that the overall system is for the application of the roof surface covering 12 to the existing roof location 16 of the building 18. The portion 10A shown within FIG. 1 is for the application of a fluid 28 to the existing roof location 16. The fluid 28 has adhesive properties. Also, the fluid 28 may have any combination of properties such as: durable, weather-resistant, waterproof, sealing, etc. Still further, the fluid 28 may be colored for aesthetic appearances. In due course, the fluid 28 dries or cures, and becomes a non-fluid solid that remains in place upon the roof location 16.

The fluid 28 may be supplied/contained in a container 30 delivered to the location of the building 18. The container 30 is a reservoir of the fluid 28. Within the shown example of FIG. 1, the container 30 is a bucket 30; however, other containers may be utilized. A first fluid conduit 32 extends from the bucket 30 to a pump 36. The pump 36 will draw the fluid 28 from the bucket 30 and move the fluid along the conduit 32 as represented by the arrowheads. The first conduit 32 extends from an output side from the pump 36. The first conduit 32 is connected to a valve 40. In turn, the first conduit 32 extends from the valve 40 to a roller applicator device 42 of the system 10. Herein, the roller applicator device 42 may be referred to simply as the roller device 42.

The roller device 42 includes a distribution head 44, which in turn includes a nap roller 46. The roller 46 is engagable with the roof location 16 (e.g., the existing roof system 22 thereat) for distribution of the fluid 28 for the roof surface covering. Accordingly, the fluid 28 moves from the bucket 30 along the first conduit 32 through the pump 36 and valve 40 and to the roller device 42. In turn, the fluid 28 exits the roller device 42 at the distribution head 44 and roller 46 and onto the roof location 16.

It should be noted although a roller applicator device is provided within the shown example it is contemplated that the applicator device may have a different configuration/construction. For example, the applicator device may be a spray applicator device that sprays the fluid onto the existing roof location.

Turning back the example shown within FIG. 1, the valve 40 is also connected to a second fluid conduit 50 that extends to the bucket 30. The valve 40 is configured such that fluid 28 may be returned or shunted back to the bucket 30 through the second conduit 50 as represented by the single arrowhead. The return of fluid 28 to the bucket 30 may be for various purposes. One purpose is to permit the pump 36 to be continuously operated despite the operational state of the roller device 42 to distribute fluid 28 to the roof location 16. In such circumstance, the fluid 28 is routed to the bucket 30 rather than routed to the roller device 42. Another operation of the valve 40 could be for pressure relief in the event that pressure exceeds a desired pressure value. In such circumstance, fluid 28 is routed from the valve 40 through the second conduit 50 and to the bucket 30 to possibly avoid an otherwise adverse pressure conditions.

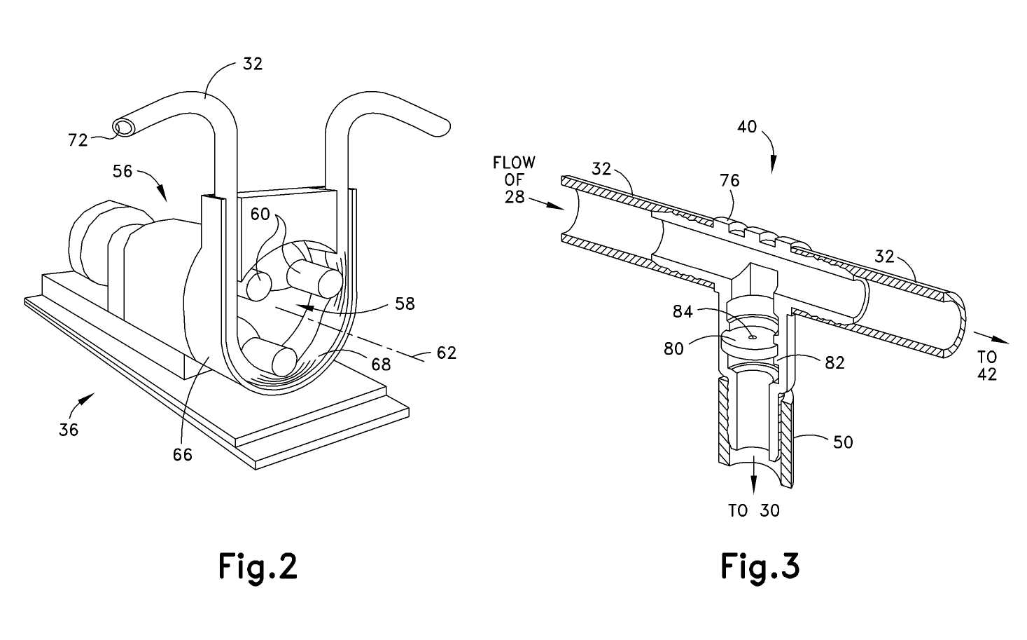

Turning to the pump 36, one specific example of a pump which may be utilized within the portion 10A of the system 10 shown in FIG. 1 is presented within FIG. 2. Specifically, the example pump 36 shown in FIG. 2 is a peristaltic pump. The pump 36 includes a drive motor 56 which is operatively connected to rotationally drive a rotational pump head 58. Located on the pump head 58 are a series of projections/rollers 60. Within the shown example, there are three rollers 60 located on the rotational pump head 58. Each roller 60 is at a radial distance from a center rotational axis 62 of the pump head 58. Also, each roller 60 is at an arc segment distance from the adjacent rollers. In the example with three rollers 60, each roller is spaced an arc distance of approximately 120° from the adjacent rollers.

The peristaltic pump 36 also includes a surrounding housing 66 within which the rotational pump head 58 is rotationally supported. The housing 66 has an arcuate interior surface 68. Specifically the interior surface 68 has a general U-shaped configuration. The rotational pump head 58 is supported such that the rollers 60 are moved in a circular manner relative to the surrounding housing 66 and each roller is sequentially moved along in close proximity to the bottom segment of the U-shaped interior surface 68 of the housing 66. It is to be appreciated that a cover plate (not shown) of the pump 36 is removed for ease of showing the rotational pump head 58, interior surface 68, etc. The cover plate fits against the axial end of the housing 66 (i.e., closed surface as shown in FIG. 2) and is secured thereto.

In connection with this shown peristaltic pump example, at least a portion of the first conduit 32 extends through the pump 36. Moreover, the first conduit 32 is flexible tubing. Thus, the flexible tubing 32 extends through the peristaltic pump 36. By that, the tubing 32 is bent into a general U-shape to follow the contour of the interior surface 68 of the housing 66 and is located between the rollers 60 of the rotational pump head 58 and the interior surface of the housing. As each roller 60 of the rotational pump head 58 is rotated, the roller will engage the flexible tubing 32 and squeeze upon the flexible tubing against the interior surface 68 (see squeezing shown within FIG. 2). Fluid 28 that is located within the flexible tubing 32 is moved along the tubing via the squeezing action of the roller 60. With the left side of FIG. 2 being an inlet side and the right side of FIG. 2 being an outlet side, the rotational pump head 58 would be rotated counter-clockwise as viewed within FIG. 2.

Such progressive squeezing to move the fluid 28 is such that the fluid only engaging an interior surface 72 of the tubing 32. The fluid 28 does not directly engage any surface of the peristaltic pump 36. Of course, it is to be appreciated that other constructions and either other types of pumps could be utilized. However, the use of the example peristaltic pump 36 provides that the fluid, which may be adverse to pump parts and/or difficult to remove or clean, need not contact portions of the pump. Thus, there is little to no impact upon the pump 36 from the fluid 28. Also, the fluid 28 does not need to be removed/cleaned from the pump 36. In order to “clean-up” after a task of supplying fluid 28 for application to the existing roof location 16, the segment of the conduit (tubing) 32 extending through the pump 36 need only be removed from the pump. The conduit (tubing) 32 may be cleaned of fluid. However, it is contemplated that disposal of the conduit (tubing) 32 would eliminate the need to clean the conduit (tubing).

Turning to the valve 40, attention is directed to the example shown in FIG. 3. The first conduit 32 is interconnected to a T-shaped member 76 (herein referred to as a “Tee”) of the valve 40. A top (as viewed in FIG. 3) of the Tee 76 provides a direct connection for the continuation of the first conduit 32 as the first conduit extends toward the roller device 42 as shown in FIG. 1. A bottom (as viewed in FIG. 3) of the Tee 76 is connected to the second, return conduit 50 which directs fluid back toward the bucket 30.

Located within the bottom (as viewed in FIG. 3) portion of the Tee is a break-away disc 80. The disc 80 is seated into an interlocking portion 82 of the Tee 76. The disc 80 of the shown example includes an open aperture 84. Fluid 28 may freely flow through the open aperture 84. As such, during operation, fluid 28 may constantly flow through the aperture 84 in a direction of return toward the bucket 30. However, it should be noted that the cross-sectional area of the aperture 84 is much smaller than the smallest restriction that would be encountered at the Tee 76 of the valve 40 as the fluid 28 flows toward the roller device 42. As such, the path of least resistance is toward the roller device 42. However, it is possible that flow of fluid 28 within the conduit 32 toward the roller device 42 may be interrupted (e.g. shut-off at the roller device or otherwise obstructed). In such circumstance, fluid 28 may be returned to the bucket 30 albeit with greater resistance due to the small diameter of the aperture 84 in the disc 80.

It should be noted that the break-away disc 80 is constructed and/or configured such that upon occurrence of a sufficient pressure differential from one-side of the break-away disc to the other side of the break-away disc the disc will yield to permit a greater volume of flow along the second, return conduit 50 toward the bucket 30. The yielding may be in the form of splitting open, cracking, deforming to allow the greater flow of fluid to the second conduit 50 and toward the bucket 30. Thus the disc 80 can be considered to be actuable to permit a greater fluid flow than merely the flow through the open aperture 84.

Returning to the topic of cleaning, it is to be noted that the shown example of the valve 40 (e.g., Tee 76 and the disc 80 located therein) are of somewhat simplistic construction. It is to be appreciated that different, and possibly more complicated, structures may be employed. However, such simplistic construction may allow for easier cleaning of fluid from the valve 40. Moreover, it is contemplated that the entire valve 40 (i.e., Tee and disc) may be disposed of without cleaning of the fluid from the valve.

As mentioned, it is to be appreciated that one step of the process of applying a roof surface covering 12 to the existing roof location includes the application of the fluid 28 to the existing roof location 16. This step is schematically shown in FIG. 1 via the arrowheads proceeding to the existing roof location 16. As can be appreciated upon review of FIG. 1, at least some of the existing roof location is to be coated with the fluid 28 (i.e., note that only part of the roof location is shown as having been coated). Eventually, it is contemplated that the entire existing roof location 16 will be coated with the fluid. However, it is possible to complete application of the new roof surface covering 12 in a series of alternations that include the application of fluid as just mentioned. Within the shown example of FIG. 1 the application is via the shown roller device 42. It is to be appreciated that other devices and methodology may be utilized to apply the fluid. For example, the fluid may be sprayed upon the existing roof location.

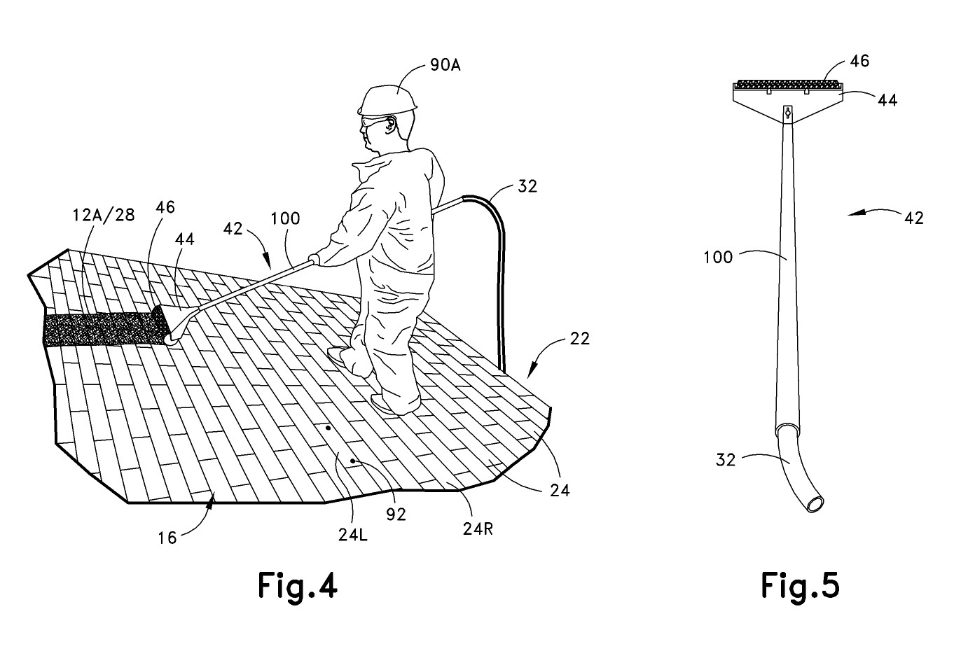

Focusing again upon the presented example that utilizes the roller device 42, attention is directed to FIG. 4 which shows an operator 90A applying the fluid 28 with the example roller device 42 in an example manner onto the existing roof location 16. Note that the nap roller 46 of the roller device 42 is in contact with the existing roof location 16 and thus fluid 28 is being transferred from the roller to the roof location.

As shown in FIG. 4, the existing roof location 16 has the existing roof system 22 located thereon. Specifically, the existing roof system 22 includes attached shingles 24. It is to be appreciated, that roof locations need not have such a preexisting roof system 22. However, focusing upon the preexisting roof system 22, it is to be appreciated that the existing roof system may be prepared prior to application of the fluid for the roof surface covering. For example, the existing roof system 22 may be cleaned. Specific examples of cleaning may include inspecting, washing, sweeping, vacuuming, scrubbing or the like. Such cleaning may remove debris, algae, moss or other vegetation, and loose roof material. As another example step of preparation may include drying the roof (e.g., via application of heat and/or air), chemically treating, or the like. Still further, another example step of preparation may include addressing any loose/missing shingles via replacement shingles 24R. Another example may include reattaching/tacking-down loose/curled shingles 24L. It should be noted that such reattaching/tacking-down may include driving fasteners 92 (e.g., nails/staples or the like) through the shingles to the under-structure (e.g., roof deck). Although fasteners 92 are presented within the example, adhesives could also be used. The fasteners 92 (e.g., nails/staples) may be in portions of the shingles that could be considered to be exposed (e.g., the tab portion of a three-tab shingle). This may be particularly true for tab-curled shingles 24L. However, as discussed further below, the present invention provides for a roof surface covering so that fasteners 92 at locations of the shingles 24L that would normally be considered to be exposed will be covered by the new roof surface covering. Thus, there will be no aesthetic or functional problem.

So, in general, preparing the existing shingles 24 to a flat appearance can be part of the overall method. Also, the existing roof location may include additional structures such as a turtle back, a plumbing stack and a vent. The method may include doing any needed work, such as replacement, repair, sealing, etc., to such additional structures. Still further, the method may include applying the fluid to any of such additional structures (e.g., turtle back, plumbing stack and vent), and dispensing the loose granules onto the applied fluid on the additional structure. Performing any needed work to at least one of shingles and other roof structures is done prior to applying the fluid/aggregate to provide the roof surface.

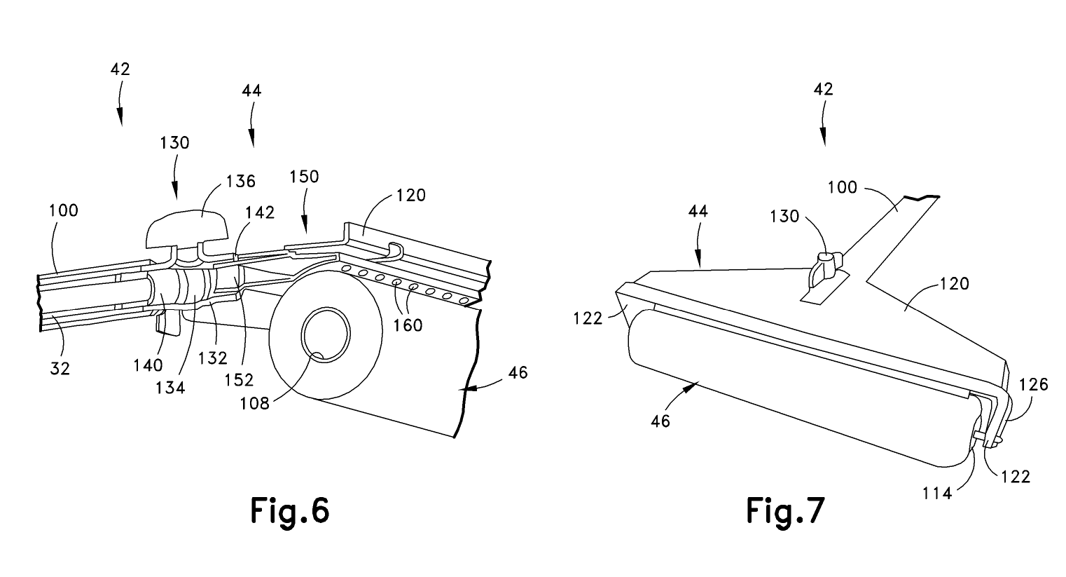

Focusing again on roller device 42, FIG. 5 shows the example roller device 42 in greater detail. As can be appreciated, the example roller device 42 has an elongate handle portion 100 which can be grasped by the operator 90A (FIG. 4). The example roller device 42 also includes the distribution head 44 with the included the nap roller 46 (see also FIG. 6 and FIG. 7).

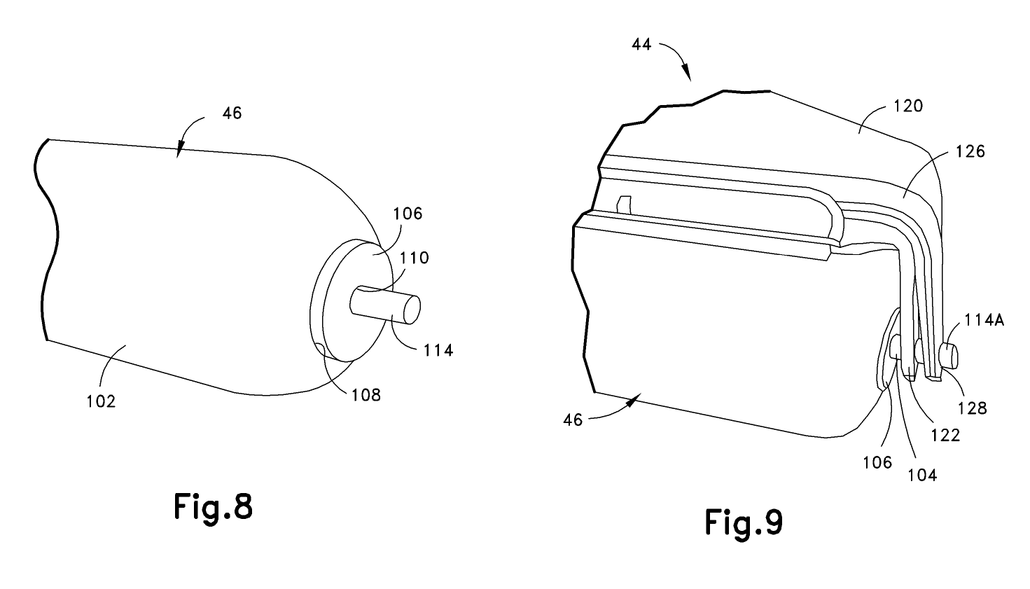

Focusing first upon the nap roller 46 (FIG. 8), the roller comprises a hollow tubular portion onto which a nap 102 is adhered. The nap 102 may be of any material/construction that can temporarily retain the fluid 28. Associated with the roller 46, the distribution head includes two end caps 106 (only one shown in FIG. 8) upon which the nap roller 46 is mounted. Specifically, an end cap 106 fits into each open end 108 of the roller 46. Each end cap 106 has a centered opening 110. An elongate member 114, such as a metal rod, extends through the centered openings 110 of the end caps 106 and through the hollow interior of the roller 46. The length of the elongate member 114 is greater than the length of the roller 46. The end caps 106 and thus the nap roller 46 are supported upon the elongate member 114. The end caps 106 rotate relative to the elongate member 114 (e.g., rotational sliding engagement).

Turning to the other structure of the distribution head 44 a shroud or cowling housing 120 (FIG. 7) extends over and across the roller 46. Specifically, the housing 120 has a width that is at least greater than the axial length of the roller 46. At each side of the housing 120 (i.e., left and right of the housing and axial ends of the roller 46) is a downwardly pointed V-yoke 122 (see also FIG. 9). In one example, the V-yoke 122 has two downwardly extending projections and a saddle or receiving area between the two projections. Since the projections and saddle face generally downward during normal use (i.e., during rolling of fluid onto the roof location), the V-yoke 122 can be referred to as inverted (i.e., an inverted V-yoke). The housing 120 extends to couple with the elongate handle portion 100 of the roller device 42. Also, the housing 120 may have other portions (.e.g. sides).

The elongate member 114 (FIG. 9) has end portions 114A that are removably located into the inverted V-yokes 122 of the housing 120 of the distribution head 44. An elastic strap or member 126 extends along a top of the housing 120 of the distribution head 44 and has an aperture 128 located at each end (only one shown in FIG. 9). The elastic member 126 may be attached to the housing 120 at a center location. The elastic member 126 may be elongated (i.e. stretched), to reach each end of the elongate member 114 seated within the respective inverted V-yoke 122. The elastic member 126 is attached to the end portion 114A of the elongate member 114 via the member extending through the aperture 128 in the end of the elastic member 126. The elastic member 126 resiliently biases and holds the elongate member 114 into the inverted yoke 122 and thus holds the nap roller 46 onto the distribution head 44.

It should be appreciated that the nap roller 46 will have fluid 28 thereon which is to be transferred to the existing roof location 16. As such, in view of the fact that the fluid 28 has adhesive properties, it may be undesirable to touch (e.g. grasp) the nap roller 46 while the fluid is located on the nap roller 46. With the configuration of the elastic member 126 holding just the end portion 114A of the elongate member 114, the elastic member may be removed from the elongate member with minimal or no contact with the fluid 28 such that the elongate member may be removed (e.g. dropped way from the distribution head 44 merely via the influence of gravity) out of the inverted yoke 122. Such, a configuration permits disposal of the nap roller 46 without need for the operator engage (grasp) the nap roller with the fluid 28 located thereon. Disposal of the roller 46 obviates the need to clean the roller. It should be appreciated that the shown example is need not be a limitation and that other configurations to allow removal of the roller with little or no contact with the fluid-laden roller are contemplated.

Turning back to FIG. 6, the shown example of the distribution head includes a manually operable valve 130 connected to an end of the first conduit 32 as the conduit extends into the handle portion 100. The valve 130 is operable to permit/meter/prevent flow of the fluid 28 through the conduit 32 and out toward the nap roller 46. Within the shown example, the valve 130 includes a body 132 with a rotatable member or stopper 134 located therein. The stopper 134 has a hole or passage there though. A manually-graspable handle 136 is rotationally fixed to the rotatable stopper 134. Rotation of the handle 136, and thus the stopper 134, relative to the valve body 132 opens/closes a variable cross-section opening provided by the hole/passage of the stopper 134. It is to be noted that the shown example of the valve 130 is somewhat simplistic in construction. Such, simplistic construction may lend itself to ease/minimal cost disposal of the valve 130 once the valve has been used. Such disposal may obviate the need for cleaning the fluid 28 from the valve 130. However, different, and possible more sophisticated valves may be utilized.

In the shown example, the valve 130 has two connection portions 140, 142. One portion 140 is for connection to the first conduit 32. This connection provides for the conduit 32 to be removable and disposable if desired (or disposal of the valve or both the conduit and valve). The second end 142 of the valve 130 is connected to a distribution manifold 150 of the distribution head 44. The distribution manifold 150 may be located/housed within the housing 120.

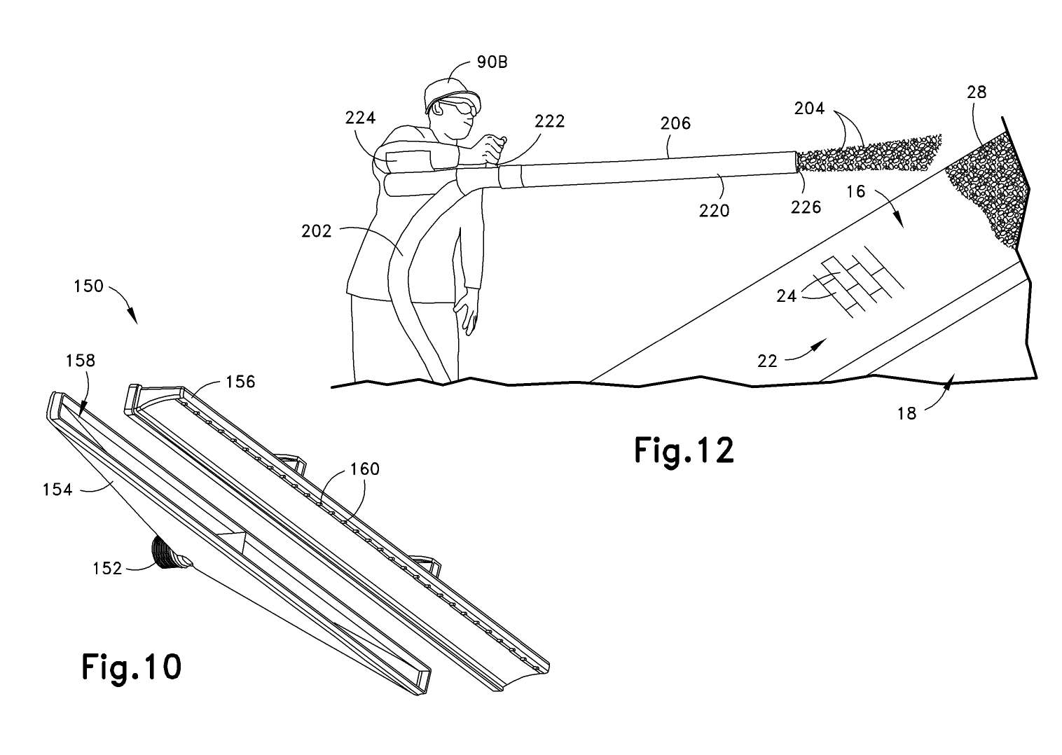

Within the shown example of the distribution manifold 150 shown in FIG. 10, the distribution manifold has an inlet 152 connected to the valve 130 and a broad portion which extends substantially the width of the distribution head 44. Also, within the shown example, the distribution manifold 150 is provided as two parts 154, 156 joined together. The first part 154 of the distribution manifold 150 includes the inlet 152 and extends laterally (side-to-side) to partially enclose a chamber 158 into which the fluid 28 may flow and distribute laterally to the left and right sides of the distribution manifold 150. The second part 156 of the distribution manifold 150 provides the remainder of the enclosure of the chamber 158. The chamber 158 at least temporarily retains the fluid 28 therein. The second part 156 has a series of apertures 160 extending along the lateral (side-to side) extend of the distribution manifold 150. The apertures 160 permit flow of fluid from the chamber 158 and out from the distribution manifold 150.

As shown in FIG. 6, the distribution manifold 150 is mounted within the distribution head 44 such that the apertures 160 of the distribution manifold are in close proximity to the nap roller 46. As the fluid 28 flows from the apertures 160, the fluid flows onto the nap roller 46. In due course, the nap roller 46 will transfer the fluid 28 onto the roof location 16.

It should be noted that the distribution manifold 150 is a removable part within an overall configuration of the distribution head 44. This permits removal and disposal of the distribution manifold 150 while retaining other portions of distribution head 44 (e.g., the housing), which may not become covered (e.g., fouled) with the fluid during use. Such disposal of the distribution manifold 150 may obviate the need to clean the distribution manifold.

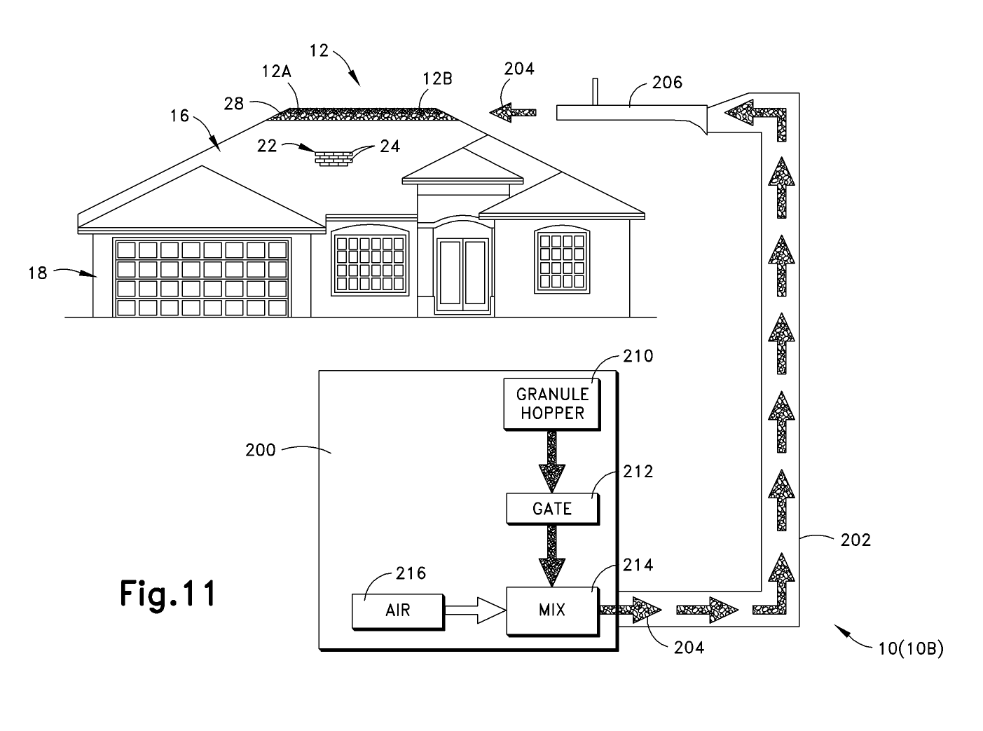

Turning to FIG. 11, another portion 10B of the system 10 for applying the roof surface covering 12 to the existing roof location 16 is shown. This portion 10B of the system 10 includes a granule supply device 200 which is connected to a granule conduit 202 and supplies loose aggregate material granules 204. The granule conduit 202 extends to a dispenser unit 206. The dispenser unit 206 distributes (applies) the aggregate material granules 204 onto the roof location 16. It is to be appreciated that the granules 204 are applied to a portion of the roof location upon which the fluid 28 has already been applied. Specifically, the dispensing of the granules 204 is onto the fluid 28 which has been applied by the portion 10A of the system 10 shown in FIG. 1. It is to be noted that the example system 10 of FIGS. 1 and 11 shows that only a portion of the new roof surface covering 12 is being provided within a single sequence of steps. It is to be appreciated that sequential steps (i.e., apply fluid to a portion of the roof location, distribute aggregate granules to the fluid-covered portion, and then repeating these two steps at another portion of the roof location) may be employed to eventually cover the entire existing roof location 16.

Focusing upon the specifics shown FIG. 11, the granule supply device 200 includes a granule hopper 210 into which aggregate material granules 204 are placed for dispensing. The granule hopper 210 is operatively connected to a gate device 212, and in turn the gate device is operatively connected to a mix device 214. The granules 204 move from the hopper 210, through the gate device 212, and to the mix device 214. The movement may be accomplished via gravity force (e.g., gravity fed) or mechanical conveyance.

Also operatively connected to the mix device 214 is an air supply 216. The air supply 216 provides moving air, under pressure, to the mix device 214. Under the influence of the moving air, the granules 204 within the mix device 214 becomes airborne (e.g., fluidized or air-suspended) and are moved into and in the granule conduit 202 toward the dispenser unit 206. Of course, it is to be appreciated that other example embodiments could be provided.

Turning to specifics of the shown example and with regard to the granule conduit 202, in one example the conduit is a flexible hollow pipe 202. The flexible pipe 202 has a diameter selected to permit flow of the air while keeping the granules 204 suspended within the air. Also, the pipe is sized so that blockage/stoppage of the granule flow is minimized or eliminated.

Attention is directed to FIG. 12 in which an operator 90B is holding and controlling an example of a dispenser unit 206 at the existing roof location 16 for the application of granules 204 onto at least a portion of the roof to which fluid 28 has been applied. It is to be noted that only part of the preexisting roof system 22, with the shingles 24, is shown for reduced drawing clutter. The dispenser unit 206 has a hollow tubular body 220, a handle portion 222 for grasping and a forearm rest 224. The tubular body 220 has an opening 226 at a forward end and is connected to the conduit 202 at a rearward end. It is contemplated that the dispenser unit 206 may be provided with or without a control mechanism for controlling flow of the air-suspended granules 204. The air-suspended granules 204 are moved (e.g. propelled) out from the open, front end and impinge upon the fluid 28 previously applied to the existing roof location 16. The granules 204 adhere to the fluid 28 because the fluid has adhesive properties. When the fluid 28 dries or cures, the granules 204 are secured in place on the dried/cured fluid.

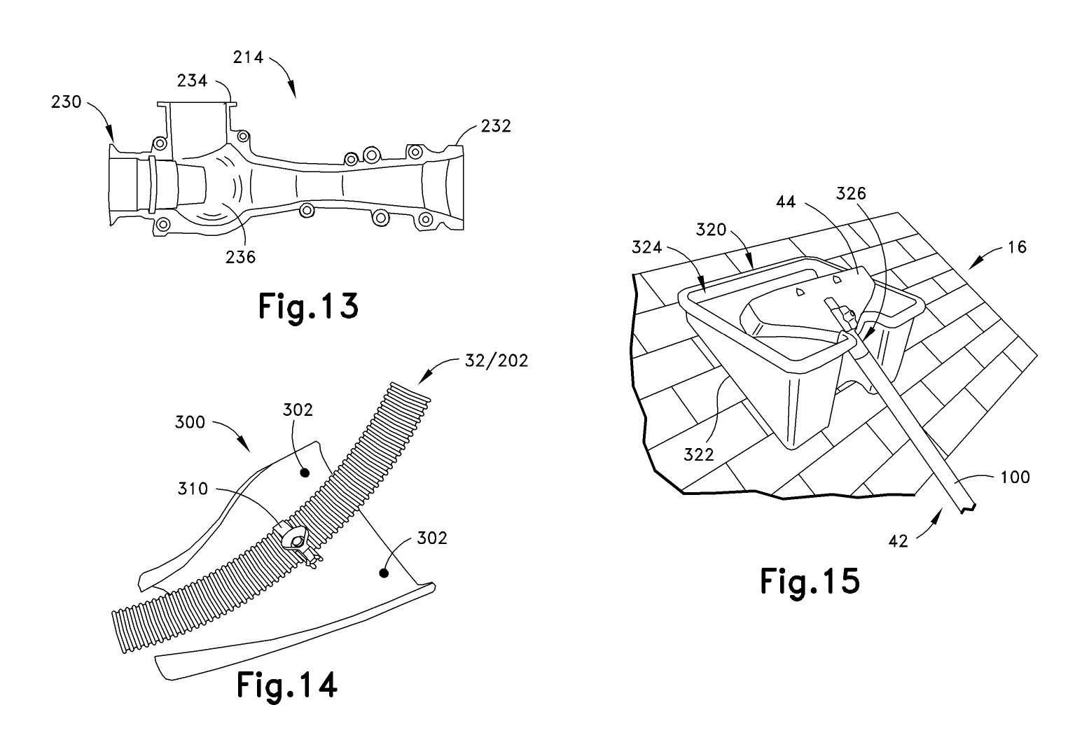

Turning to the mix device 214 (FIG. 11), it is to be appreciated that any suitable mix device that can provide the function of fluidizing or air-suspending the aggregate granules 204 may be utilized. FIG. 13 provides one such example of a mix device 214 that is an eductor 214. The eductor 214 has a first end 230 operatively connected to the air supply 216, and a second end 232 operatively connected to the granule conduit 202. The eductor 214 also includes an opening 234 operatively connected to the granule hopper 210 via the gate device 212, such that the granules 204 may fall into the eductor 214. The eductor 214 has a chamber 236 into which the granules 204 fall and also into which the air flows. Within the chamber 236, the granules 204 becomes airborne fluidized and is moved out the second end 232 via the air pressure.

The gate device 212 (FIG. 11) may have any type of structure for permitting/stopping/metering the flow of granules 204 from the hopper 210 to the mix device 214. In one example, the gate device 212 has a passage and a movable member (e.g., a sliding plate) that is moved to vary an amount of opening within the passage. The gate device 212 may include a control arrangement. The control arrangement may be a manual control, an electrical control, and may be a local or remote control. The remote control may be located with the operator 90B of the dispenser unit 206.

The granule hopper 210 may have any construction for holding a supply of the aggregate granules 204. In one example, the granule hopper 210 is a bin with an open top to allow a supply of the granules 204 to be poured into the open-top bin. It is to be noted that the granules 204 may be of any desired color. Also, it is contemplated that different color granules may be mixed. Also, it is possible to vary the granule size.

The air supply 216 may have any type of construction. For example, the air supply 216 may be an air compressor or a blower fan. Also, air compressor may be a separate unit from other portions of the granule supply device 200. For example, the air supply 216 may be a commercially available separate unit.

It is to be appreciated that the system 10 as shown within FIGS. 1 and 11 can be used to provide the covering 12 over the existing roof location 16 or only a portion if so desired. Within one specific example, the fluid 28 is applied in a sufficiently thin layer such that the fluid will follow the contour of the existing roof location 16 (e.g., the contour and specifically the texturing of the shingles 24). As such, the new roof surface covering 12 applied by the system 10 of FIGS. 1 and 11 can have an appearance very similar to a shingled roof which existed prior to the application of the new roof surface covering 12. Also, the aggregate granules 204 applied by the portion 10B showed in FIG. 11 may be of aggregate granular size similar to the previous aggregate granular size within the previous roof system 22. As such, the adhered granules will also follow the contour of the preexisting roof system 22 (e.g. the contouring of the preexisting roof shingles 24). Thus again, the appearance of a shingled roof can be maintained/mimicked. Also, it is to be appreciated that the adhesive fluid 28 may be colored as desired. Still further, the applied aggregate granules 204 (applied by the portion 10B of FIG. 11) may be colored to any desired color. Accordingly, it is possible the roof surface covering 12 applied by the system of FIGS. 1 and 11 may have a difference color appearance than the preexisting roof system 22. Also, it should be appreciated that the new roof surface covering 12 is continuous so that old previous leaks in the previous roof system can be covered. Still further, defects, mismatched colors in the shingles (possibly due to repair/replacement) are covered over by the new roof surface covering 12.

It should be appreciated that other optional aspects can be provided. For example, it is to be contemplated that the preexisting roof system 22 may be repaired and/or treated prior utilization of the system of FIGS. 1 and 11 to apply the new roof surface covering. For example, the preexisting roof may be cleaned of debris and/or loose roofing aspects (loose shingles or shingle portions). Still further, missing and/or torn shingles may be replaced or repaired. It is to be noted that the replacement or repaired shingles may not be of a matching color to the preexisting roof and/or the roof surface covering that will be applied via the system shown in FIGS. 1 and 11 since the roof surface covering will coat and cover such replacement shingles. Still further, it should be noted that the preexisting roof system may be prepared or otherwise worked upon in a manner that would otherwise be disfavorable and/or egregious if the preexisting roof system were to not be coated with the new roof surface covering via the system within FIGS. 1 and 11. For example it is contemplated that curled or lifted exposed shingle edges or the corners or the like can be tacked down via nails or staples. Normally such exposed nails or staples could possible cause leakage if the preexisting roof were left in such condition. However, upon application of the roof surface covering via the system shown in FIGS. 1 and 11 the treatment of such preexisting system does not have such harm or risks.

Still further, there may be other optional aspects that may be utilized in connection with the portions of the system shown in FIGS. 1 and 11. For example, FIG. 14 shows a guide 300 which can be attached to the roof location 16 near an edge of the roof. For example, the guide 300 has holes 302 for nails to pass through and into the roof. The conduits 32 and/or 202 (the fluid conduit and/or the granule conduit), may be placed within the guide 300 to prevent the conduit(s) from engaging certain portions of the roof location 16 and/or the building 18. For example, the guide 300 may be useful to prevent the conduits from engaging a gutter of the building 18. Also, the guide 300 may have a retainer 310 for gripping and retaining the conduit 32/202. Within the show example, the retainer 310 is a clamp that holds the conduit 32/202. Such a retainer 310 can help hold at least a portion of conduit 32/202 at the roof location 16 and thus prevent the conduit from sliding off of the roof location due to gravity.

FIG. 15 is an example of an optional roof stand 320. The roof stand 320 has a tapered bottom surface 322 which is angled to have a slope at least similar to a slope of tapered of the roof location 16. The stand 320 is configured to provide a basin 324 for catching fluid 28 and includes a notch 326 for receiving a segment of the handle portion 100 of the roller device 42 adjacent to the distribution head 44. Thus, the roller device 42 can be rested upon the roof stand 320 and fluid 28 that drips from distribution head 44 of the roller device 42 will be collected within the basin 324. Such a roof stand 320 helps to prevent loss of the roller device 42 from falling from the roof location 16 while not being held by an operator 90A and also prevents undesired drips onto the roof location 16.

While the roof stand 320 is shown for use with the roller device 42 it is to be appreciated that the roof stand can provide other functions. For example, if a different type of fluid applicator device is used (e.g., sprayer), the sprayer may be rested within the roof stand. Also, the roof stand 320 may be used a receptacle for other tools. Still further, the roof stand may be used as a receptacle for trash, debris and the like. Configuration of the roof stand, and in particular the tapered bottom surface 322 and the notch 326, help to provide such useful functions. With regard to the method of applying a roof surface covering to an existing roof location in accordance with an aspect of the present, the optional use of the roof stand 320 within such method provides benefits. For example, use of the roof stand 320 allows resting of the roller device 42 during the method. Such resting may help to keep the overall method proceeding. For example, stoppage without an ability to rest may entail increased mess, needed partial cleaning, retrieval if roller device is dropped.

The invention has been described with reference to the example embodiments described above. For example, the most of the presented discussion has been directed to roof locations that had previous roof systems. However, it is contemplated that the present invention may be utilized to a roof location that does not have a pre-existing roof system (i.e., no old shingles). All that is needed is a roof location (e.g., with or without shingles) since the present invention merely needs some location (e.g., structure) onto which the fluid and granule material) is applied. Modifications and alterations will occur to others upon a reading and understanding of this specification. Example embodiments incorporating one or more aspects of the invention are intended to include all such modifications and alterations insofar as they come within the scope of the appended claims.

What is claimed:

1. A system for applying a roof surface covering to an existing roof location of a building, the system including:
a pump for providing a pressurized source of fluid;
a fluid conduit for extending from the pump to the roof location and delivering the fluid to the roof location;
an applicator device for applying the delivered fluid to the roof location to provide a portion of the applied roof surface;
a granule supply device for proving loose granules;
a granule conduit for extending from the granule supply device to the roof location and delivering the loose granules to the roof location; and
a dispenser for dispensing the loose granules onto the applied fluid on the roof location to provide another portion of the applied roof surface.

2. A system as set forth in claim 1, wherein the pump is a peristaltic pump and the fluid conduit is a tubing that includes a segment that extends through the peristaltic pump.

3. A system as set forth in claim 2, wherein the tubing is structured to contain the fluid such that the fluid does not directly contact any surfaces of the pump, and the tubing and pump are structured such that the tubing is removable from the pump without directly contacting the fluid to any surfaces of the pump.

4. A system as set forth in claim 1, wherein the fluid conduit has a length sufficient to permit placement of the pump at a location remote from the roof location and the granule conduit has a length sufficient to permit placement of the granule supply device at a location remote from the roof location.

5. A system as set forth in claim 1, wherein the granule supply device includes a pressurized air source for fluidizing the loose granules within air, the granule conduit includes a pipe along which the fluidized, loose granules move toward the roof location.

6. A system as set forth in claim 1, wherein the granule supply device includes an eductor for mixing the loose granules with the air.

7. A system as set forth in claim 1, wherein the existing roof location has existing shingles that contain granules adhered to a substrate, the granule supply device is configured to prove loose granules of comparable size to the granules present within the shingles.

8. A system as set forth in claim 7, wherein the granule supply device is configured to prove loose granules of any color regardless of color of granules present within the shingles.

9. A system as set forth in claim 1, wherein the applicator device includes a roller for directly applying the delivered fluid to the roof location by rolling contact with the roof location.

10. A system as set forth in claim 1, wherein the pump draws the fluid from a reservoir of the fluid, the fluid conduit including a pressure relief valve located between the pump and the roof location, the pressure relief valve being in fluid communication with the reservoir of fluid and shunting fluid to the reservoir to prevent an undesired pressure within the fluid conduit.

11. A system as set forth in claim 10, wherein the pressure relief valve includes a constantly open orifice for permitting fluid flow toward the reservoir and an actuable portion for permitting a greater fluid flow than the orifice.

12. A system as set forth in claim 1, further including a guide for the granule conduit that includes a portion that can be secured to the building proximate the roof location.

13. A system as set forth in claim 12, wherein the guide being for overlaying at least a portion of an edge of the roof location.

14. A system as set forth in claim 12, wherein the guide includes a portion for nailing to the roof location.

15. A system as set forth in claim 12, wherein the granule conduit includes a pipe, and the guide includes a clamp for engaging and retaining a segment of the pipe.

16. A system as set forth in claim 1, wherein the dispenser includes a portion manually engagable by a user and a portion extending away from the user to direct a dispensed flow of the loose granules.

17. A system for applying a roof surface covering to an existing roof location of a building, the system including:
a peristaltic pump for providing a pressurized source of fluid;
a fluid conduit through and from the pump to the roof location and for delivering the fluid to the roof location, the fluid conduit containing the fluid and the fluid not directly engaging any surface of the pump;
an applicator device for applying the delivered fluid to the roof surface;
a granule supply device for proving loose granules fluidized within an airstream;
a granule conduit for conveying the fluidized, loose granules from the granule supply device to the roof location and delivering the loose granules; and
a dispenser for dispensing the loose granules onto the applied fluid on the roof surface.

18. A system for applying a fluid to a surface, the system including:
a peristaltic pump for providing a pressurized source of fluid;
a fluid conduit through and from the pump to surface location and for delivering the fluid to the surface location, the fluid conduit containing the fluid and the fluid not directly engaging any surface of the pump; and
an applicator device for applying the delivered fluid to the surface, the applicator device including a handle for manual grasping by a user, a head for receiving the fluid from the source, and a roller located at the head for transferring the fluid from the head to the surface during a rolling motion of the roller relative to the head.

19. A method for applying a roof surface covering to an existing roof location of a building, the method including:
operating a pump to provide a pressurized source of fluid;
moving the fluid within a fluid conduit extending from the pump to the roof location and delivering the fluid to an applicator device;
operating the applicator device to apply the fluid to the roof surface;
operating a granule supply device to provide loose granules;
conveying the loose granules along a granule conduit from the granule supply device to the roof location; and
dispensing the loose granules onto the applied fluid on the roof surface via a dispenser connected with the granule conduit.

20. A method as set forth in claim 19, further including the following steps prior to the step of operating the applicator device: performing any needed work to at least one of shingles and other roof structures.

21. A method as set forth in claim 19, wherein the existing roof location includes at least one of turtle back, plumbing stack and vent, the method includes applying the fluid to the at least one of turtle back, plumbing stack and vent, and dispensing the loose granules onto the applied fluid on the at least one of turtle back, plumbing stack and vent.

22. A method as set forth in claim 19, wherein the pump is a peristaltic pump and the fluid conduit is a tubing that includes a segment that extends through the peristaltic pump, and the step of operating the pump includes operating the peristaltic pump.

23. A method as set forth in claim 19, wherein the step of operating the pump includes operating the pump such that the fluid does not directly contact any surfaces of the pump.

24. A method as set forth in claim 19, wherein the existing roof location includes at least one of: a deteriorated shingle, a replacement shingle, and a shingle secured in place via a fastener applied at an exposed location.

25. A method as set forth in claim 19, wherein the fluid conduit has a length sufficient to permit location of the pump at a location remote from the roof location and the granule conduit has a length sufficient to permit location of the granule supply device remote from the roof location.

26. A method as set forth in claim 19, wherein the granule supply device includes a pressurized air source for fluidizing the loose granules within air, the granule conduit includes a pipe along which the fluidized, loose granules move toward the roof location.

27. A method as set forth in claim 19, wherein the granule supply device includes an eductor for mixing the loose granules with the air.

28. A method as set forth in claim 19, wherein the existing roof location has existing shingles that contain granules, the step of operating the granule supply includes providing loose granules of any color regardless of color of granules present within the shingles.

29. A method as set forth in claim 19, wherein the applicator device includes a roller for directly applying the delivered fluid to the roof location by rolling contact with the roof location.

30. A method as set forth in claim 19, wherein the step of operating a pump includes drawing the fluid from a reservoir of the fluid by the pump, the fluid conduit including a pressure relief valve located between the pump and the roof location, the pressure relief valve being in fluid communication with the reservoir of fluid and shunting fluid to the reservoir to prevent an undesired pressure within the fluid conduit.

31. A method as set forth in claim 30, wherein the pressure relief valve includes a constantly open orifice for permitting fluid flow toward the reservoir and an actuable portion for permitting a greater fluid flow than the orifice.

32. A method as set forth in claim 30, including resting the applicator device within a roof stand.

33. A method for repairing an existing roof location by applying a new roof surface covering that includes:
applying a fluid while in a liquid state directly to an existing roof location which will subsequently dry or cure to become a non-liquid that remains adhered to the existing roof location; and
applying a granules onto the fluid while the liquid is in the liquid state such that some portion of the granules remain exposed while still being adhered to the fluid after it subsequently dries or cures to a non-liquid state.

34. A method as set forth in claim 33, wherein the fluid creates a waterproof covering on the existing roof location after drying or curing to a non-liquid state.

35. A method as set forth in claim 33, wherein the fluid creates a durable surface that resists damage from impacts and/or other environmental exposure factors.

36. A method as set forth in claim 33, wherein at least one of the fluid and the granules includes a coloration for aesthetics.

37. A roller applicator device for applying a fluid to a location, the device including:
a handle portion for manual grasping by a user;
a connection portion for connection to a pressurized source of the fluid;
a distribution head for receiving the fluid from the source via the connection portion;
a roller located at the distribution head for transferring the fluid from the distribution head to the location during a rolling motion of the roller relative to the location, the roller including at least one member rotationally supporting the roller relative to the distribution head, the distribution head including at least one engagement portion for engaging the at least one member; and
at least one retainer for retaining the at least one member and the roller relative to the head during the rolling motion of the roller;
the at least one member, the at least one engagement portion and the at least one retainer being constructed and configured to permit release of the roller from the head without engagement of the roller by the user.

38. A device as set forth in claim 37, wherein the at least one member includes an elongate member extending within the roller and having end portions located at axial opposite ends of the roller, the at least one retainer includes at least one resilient member stretchable to engage the end portions of the elongate member and provide a retaining force to hold the elongate member in engagement with the at least one engagement portion.

39. A device as set forth in claim 38, wherein the at least one resilient member includes an elastic strap.

40. A device as set forth in claim 38, wherein the at least one engagement portion includes at least one V-yoke for receiving an end portion of the elongate member, the at least one resilient member provides a force to retain the end portion of the elongate member within the V-yoke.

41. A device as set forth in claim 37, wherein the head includes a distribution manifold for distributing the fluid along an axial length of the roller at an exterior of the roller.

42. A device as set forth in claim 37, wherein the fluid has an adhesive attribute, and the port, the head and the roller are configured to transfer and apply the fluid with the adhesive attribute.
